(19) United States
(12) Patent Application Publication
(10) Pub. No.: US 2022/0370961 A1
(43) Pub. Date: Nov. 24, 2022

(54) 2D MATERIAL MEMBRANE WITH IONIC SELECTIVITY

(71) Applicant: National University of Singapore, Singapore (SG)

(72) Inventors: Slaven Garaj, Singapore (SG); Massimo Spina, Singapore (SG)

(73) Assignee: National University of Singapore, Singapore (SG)

(21) Appl. No.: 17/767,317

(22) PCT Filed: Oct. 7, 2020
(86) PCT No.: PCT/SG2020/050566

§ 371 Date: Apr. 7, 2022

(30) Foreign Application Priority Data
Oct. 7, 2019 (SG) 10201909362Q

(51) Int. Cl. B01D 69/12; B01D 61/00; B01D 61/46; B01D 63/08; B01D 67/00; B01D 71/02; B01D 69/02; C02F 1/44; C02F 1/469; C01B 32/21; C01B 21/068

(52) U.S. Cl. CPC B01D 69/1216; B01D 61/0022; B01D 61/46; B01D 63/088; B01D 67/0062; B01D 69/1213; B01D 71/0213; B01D 71/0215; B01D 71/0211; B01D 69/02; C02F 1/445; C02F 1/4693; C01B 32/21; C01B 21/0682; B01D 2325/02833; B01D 2325/02834; B01D 2325/0283; B01D 2325/04; B01D 2325/26; B01D 2325/36; B01D 2325/38; C01P 2006/40

(57) ABSTRACT

There is provided a multi-layered membrane comprising a top layer, a bottom layer, and a spacer layer; wherein said spacer layer is interposed between said top layer and said bottom layer; wherein said top layer, said bottom layer and said spacer layer are each independently composed of one or more selective layers, each selective layer comprising a 2D material; wherein said spacer layer comprises at least one channel for receiving a fluid; wherein said bottom layer comprises a hole with an area in the range of 1 μm² to 1 mm²; and wherein said hole is capable of being in fluid communication with said at least one channels of said spacer layer.

There is also provided a method to synthesize the top layer of a multi-layered membrane as disclosed herein, methods for separating a plurality of ions or molecules in a fluid stream, a device comprising a multi-layered membrane as disclosed herein, and use of the method or the device as disclosed herein in osmotic power generation.

### REFERENCES TO RELATED APPLICATION

This application claims priority to Singapore application number 10201909362Q filed on 7 Oct. 2019, the disclosure of which is hereby incorporated by reference.

### TECHNICAL FIELD

The present invention relates to a multi-layered membrane comprising a top layer, a bottom layer and a spacer layer. The present invention also relates to a method to synthesize the top layer of the multi-layered membrane as disclosed herein, methods for separating a plurality of ions or molecules in a fluid stream, a device comprising a multi-layered membrane, and use of the method or the device as disclosed herein in osmotic power generation.

### BACKGROUND ART

Two-dimensional (2D) materials can be used to create membranes comprising nanocavities, for example, nanochannels, nanopores, or nanotubes, with critical dimension as low as 0.3 nm. Ions and water molecules inside these nanocavities behave differently than in the bulk phase because of their physical confinement and strong interaction with the surface of these nanocavities, resulting in different ionic mobilities compared to their bulk phase and different mobilities between cations and anions.

Presently, state-of-the-art studies in 2D materials-based nanocavities focused mainly on the electrostatic confinement and water flow in nanochannels. Earlier studies of similar structures pointed out the ionic physical confinement and showed a reduction in ionic mobilities especially for anions (i.e. chlorine ions). However, enhanced ionic mobilities and other uses of such membranes were never reported nor speculated.

Therefore, there is a need to provide a membrane or a multi-layer membrane comprising the 2D material-based nanocavities that can be used, for example, to generate osmotic voltage/current.

### SUMMARY

In one aspect, the present disclosure relates to a multi-layered membrane comprising a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of 1 μm² to 1 mm²; and wherein the hole is capable of being in fluid communication with the at least one channel of the spacer layer.

Advantageously, the multi-layered membrane as disclosed herein may be intrinsically uncharged and therefore, may be energy-free, offering the multi-layered membrane an additional degree of freedom to be engineered for its ionic selectivity. The ionic selectivity of the multi-layered membrane may be tuned based on the dimension of the channel and the type of 2D material used.

Further advantageously, the multi-layered membrane as disclosed herein may possess atomically smooth surfaces comprising channels in the critical dimension ranging from about 0.3 nm to about 250 nm, which may enable the multi-layered membrane to be ionic and/or charge selective by selectively enhancing the mobility of cations and/or anions in the channels with respect to their mobility in the bulk. This may be attributed to the interaction between the cations and anions with the surfaces of the channels which is dependent on the intrinsic property of the channels' surfaces as well as the degree of physical confinement of the cations and anions in the channels. The enhanced mobility of the cations and/or anions may be independent of surface charge or roughness of the channels. The multi-layered membrane with its enhanced mobility of the cations or anions than the respective counter ion, may result in the counter-ion rejection which does not affect the water permeation properties of the multi-layered membrane.

Further advantageously, the multi-layered membrane as disclosed herein with its enhanced ionic mobility may in turn enhance ionic conductivity of the solution regardless of the pH of the ionic or electrolyte solution, since ionic conductivity is significantly related to the ionic diffusivity at the surface. This is because the interaction between the walls of channels and ions in an electrolyte solution may occur via delocalized 7c-electrons on the walls of the channels (for example, walls of graphene), giving rise to preferential absorption of cations. Hence, the preferential absorption of the cations may be combined with the preferred alignment of water molecules in the near-surface region, resulting in the enhanced diffusivity of cations and reduced flow of anions in a cation selective multi-layered membrane, or enhanced diffusivity of anions and reduced flow of cations in an anion selective multi-layered membrane.

Further advantageously, the width of the hole in the bottom layer may influence the thickness of the top layer, as the larger the width of the hole in the bottom layer, the thicker the thickness of the top layer may be required to prevent the bending of the selective layers within the top layer, which may in turn impact the overall multi-layered membrane performance. When the width of the hole in the bottom layer is reduced, it may allow a thinner top layer to be used without any unwanted bending effects.

Further advantageously, the multi-layered membrane as disclosed herein may be deposited on a support or embedded in a matrix, to serve as an active multi-layered membrane when it is incorporated into another membrane or system.

Still further advantageously, the multi-layered membrane as disclosed herein may be about 30 times cheaper and may generate about 1000 times more power for the same surface area compared to conventional membranes, thus making it cost effective and energy efficient for commercial applications.

In another aspect, the present disclosure relates to a method to synthesize a top layer of a multi-layered membrane as disclosed herein, comprising the steps of: (a) providing a spacer layer/bottom layer assembly; (b) dry transferring a selective layer comprising a 2D material on top of the spacer layer of the spacer layer/bottom layer assembly; (c) depositing a metal layer or metal oxide layer on top of the selective layer of step (a) to form a mask; and (d) subjecting the metal layer or metal oxide layer to an etching process.

In another aspect, the present disclosure relates to a method for separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein bottom layer comprises a hole that is capable of being in fluid communication with the at least one channel of the spacer layer.

In another aspect, the present disclosure relates to a method for separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of 1 μm² to 1 mm²; and wherein the hole is capable of being in fluid communication with the at least one channel of the spacer layer.

Advantageously, given that the method as disclosed herein comprises the use of a multi-layered membrane which has ionic selectivity, an osmotic voltage and/or an osmotic current may be generated and thus, the method may be suitable for blue energy generation and storage where there is salinity gradient, for example in water desalination plants, nanofiltration, ion-exchange, brine-disposal and water filtration operations, and may find many commercial applications in water purification, pharmaceutical, chemical and fuel separation industries.

In another aspect, the present disclosure relates to a device comprising a multi-layered membrane comprising a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of 1 μm² to 1 mm²; and wherein said hole is capable of being in fluid communication with the at least one channel of the spacer layer.

Advantageously, the device as disclosed herein may be used for energy recovery.

Further advantageously, the device as disclosed herein may form part of an electrodialysis system or reverse electrodialysis, when two sets of multi-layered membranes as defined herein have opposite charge selectivity.

In yet another aspect, the present disclosure relates to use of the method or the device as disclosed herein in osmotic power generation.

Therefore, there is provided use of a device comprising a multi-layered membrane for osmotic power generation wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein the bottom layer comprises a hole that is capable of being in fluid communication with the at least one channel of the spacer layer.

### Definitions

The following words and terms used herein shall have the meaning indicated:

The term “2D material” as used herein refers to a single-layered material which is crystalline and consists of a single layer of atoms.

The term “nanochannels” as used herein refers to channels which are dimensioned in the nanometre-size range from 0.1 nanometre to hundreds of nanometres.

The term “ionic mobility” as used herein refers to the speed achieved by an ion when moving through a substance in response to an electrochemical gradient.

The term “ionic conductance” as used herein refers to the physical property of a substance denoting the ease of which an ion transmits from one site to another.

The term “transference number” as used herein refers to ion transport number, which is the fraction of the total electrical current carried in an electrolyte by a given ionic species, where difference in transference number arises from difference in ionic mobility.

The term “graphene” as used herein refers to an allotrope of carbon consisting of a single layer of atoms arranged in a two-dimensional hexagonal array, wherein each atom in the graphene sheet is connected to its three nearest neighbours by a σ-bond, and contributes one electron to a conduction band that extends over the whole layer.

The term “graphite” as used herein refers to a type of crystal carbon composing of more than ten graphene layers stacked loosely.

The term “blue energy” as used herein refers to osmotic power which occurs in a concentration cell with salinity gradient across two sides, and a semi-permeable membrane in between the two sides capturing the electrochemical potential generated into energy due to the movement of the water molecules between the two sides.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### Detailed Disclosure of Embodiments

Exemplary, non-limiting embodiments of a multi-layered membrane will now be disclosed.

The multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of about 1 μm² to 1 mm²; and wherein the hole is capable of being in fluid communication with the at least one channel of the spacer layer.

The area of the hole may alternatively be in the range of about 10 μm² to about 1 mm², about 100 μm² to about 1 mm², about 1000 μm² to about 1 mm², about 0.01 mm² to about 1 mm², about 0.1 mm² to about 1 mm², about 1 μm² to about 10 μm², about 1 μm² to about 100 μm², about 1 μm² to about 1000 μm², about 1 μm² to about 0.01 mm², about 1 μm² to about 0.1 mm², about 10 μm² to about 100 μm², about 10 μm² to about 1000 μm², about 10 μm² to about 0.01 mm², about 10 μm² to about 0.1 mm², about 100 μm² to about 1000 μm², about 100 μm² to about 0.01 mm², about 100 μm² to about 0.1 mm², about 1000 μm² to about 0.01 mm², about 1000 μm² to about 0.1 mm², or about 0.01 mm² to about 0.1 mm².

The width of the hole may be in the range of about 20 nm to about 2 μm, about 100 nm to about 2 μm, about 500 nm to about 2 μm, about 1 μm to about 2 μm, about 1.5 μm to about 2 μm, about 20 nm to about 100 nm, about 20 nm to about 500 nm, about 20 nm to about 1 μm, about 20 nm to about 1.5 μm, about 100 nm to about 500 nm, about 100 nm to about 1 μm, about 100 nm to about 1.5 μm, about 500 nm to about 1 μm, about 500 nm to about 1.5 μm, or about 500 nm to about 1.5 μm; and

the length of the hole may be in the range of about 20 nm to about 1 mm, about 100 nm to about 1 mm, about 1000 nm to about 1 mm, about 0.001 mm to about 1 mm, about 0.01 mm to about 1 mm, about 0.1 mm to about 1 mm, about 20 nm to about 100 nm, about 20 nm to about 1000 nm, about 20 nm to about 0.001 mm, about 20 nm to about 0.01 nm, about 20 nm to about 0.1 mm, about 100 nm to about 1000 nm, about 100 nm to about 0.001 mm, about 100 nm to about 0.01 mm, about 100 nm to about 0.1 mm, about 1000 nm to about 0.001 mm, about 1000 nm to about 0.01 mm, about 1000 nm to about 0.1 mm, about 0.001 mm to about 0.01 mm, about 0.001 mm to about 0.1 mm, or about 0.01 mm to about 0.1 mm.

It is to be noted that, while the terms “top layer” and “bottom layer” can be regarded as relative terms that depend on the orientation by which the multi-layered membrane is viewed at, as long as the layer is one that contains a hole, that layer is to be regarded as the “bottom layer” regardless of whether it is seen as the first layer when viewed according to a certain orientation (for example, when viewing the membrane from the bottom, the first layer would still be regarded as the “bottom layer” and not the “top layer” as it is the layer with the hole therein).

The 2D material may be a nanoparticle.

The 2D material may be selected from the group consisting of graphene, graphite, hexagonal boron nitride, transition metal dichalcogenide, phosphorene, xene, transitional metal-xene and combinations thereof. The 2D material may preferably be one or more layers of graphene. The 2D material may be graphite which may be composed of more than ten graphene layers.

The transition metal dichalcogenide has a chemical formula MX2, wherein M may be a transition metal selected from the group consisting of titanium, vanadium, chromium, manganese, zirconium, niobium, molybdenum, technetium, hafnium, tantalum, tungsten and rhenium; and wherein X may be a chalcogen selected from the group consisting of sulfur, selenium and tellurium.

The xene may be selected from the group consisting of borophene, silicene, germanene, stanene, phosphorene, arsenene, antimonene, bismuthene, and tellurene. The transition metal-xene may be selected from the group consisting of mono or double transition metal-xene.

The channels may be nanochannels. The channels may be straight, percolative or combinations thereof. The shape of the channels may depend on the type of 2D material used. When the 2D material is graphene, the channels may be straight.

The shape of the hole in the bottom layer may not be particularly limited and may be a square, a rectangle or a circle.

The width of the hole in the bottom layer may influence the thickness of the top layer, as the larger the width of the hole in the bottom layer, the thicker the thickness of the top layer may be required to prevent the bending of the selective layers within the top layer, which may in turn impact the overall multi-layered membrane performance. When the width of the hole in the bottom layer is reduced, it may allow a thinner top layer to be used without any unwanted bending effects.

The bottom layer or spacer layer may independently comprises one or more layers of a substrate, which may be present during formation of the layers but which may be removed when combining the layers together during multi-layered membrane formation. The substrate may be independently selected from the group consisting of silicon, silicon nitride (SiN_{X}), silicon oxide (SiO₂), alumina (Al₂O₃), anodic aluminium oxide, aluminium oxide, titanium dioxide, hafnium dioxide, nylon, polymer, polyether sulfone, polyvinyl alcohol (PVA), polycarbonate (PC), and polyvinylidene fluoride. When formed into the multi-layered membrane, the bottom layer is supported on the substrate while the spacer layer does not contain the substrate.

Since graphene and other 2D materials may not be visible in the visible wavelength range by optical microscopy, the use of silicon oxide as a reflecting substrate may enhance optical contrast and hence allow the selective layers of the bottom layer or spacer layer to be visible for ease of identification during multi-layered membrane synthesis, such as after the step of mechanical exfoliation. For optimal contrast, the silicon oxide substrate may have a thickness in the range of about 80 nm to about 500 nm, and preferably at about 300 nm.

The bottom layer comprising one or more layers of substrate may be supported on the surface of the one or more layers of substrate. The one or more layers of substrate may improve the overall mechanical strength of the structure of the multi-layered membrane. In this manner, the one or more layers of substrate function(s) as a mechanical support for the bottom layer. It is to be noted that reference to the hole in the bottom layer (or reference to the dimension of the hole in the bottom layer, such as area, width or length of the hole) is regarded as the hole present in the bottom layer that is made up of the 2D material, and not to the hole in the substrate of the bottom layer.

The top layer, bottom layer or spacer layer may be optionally subjected to surface chemical functionalization, forming a top layer, bottom layer or spacer layer that is surface-functionalized. The surface chemical functionalization may alter the properties of the selective layer.

The surface chemical functionalization may be applied on the surfaces, entries or exits of the selective layers of the top layer, bottom layer or spacer layer.

The surface chemical functionalization may enhance the hydrophilicity or hydrophobicity of the top layer, bottom layer or spacer layer. Therefore, the surface-functionalised top layer, surface-functionalised bottom layer or spacer surface-functionalised layer may have a different hydrophilicity or hydrophobicity as compared to a non surface-functionalized corresponding layer. Surface chemical functionalization may be undertaken using different chemical groups to enhance the performance of the membrane such as to increase the selectivity towards targeted ions or molecules, or to reduce fouling of the multi-layered membrane.

The surface chemical functionalization may be selected from the group consisting of hydrogenation, fluorination, oxidation, silanization, hydroxylation and carboxylation. When graphene is used as the selective layer and subjected to hydrogenation, the treated graphene layer may be more hydrophilic than the untreated graphene layer. When graphene is used as the selective layer and subjected to fluorination, the treated graphene layer may be more hydrophobic than the untreated graphene layer.

The bottom layer, top layer or spacer layer may be patterned or etched. The bottom layer comprising one or more layers of substrate may be patterned or etched

The bottom layer, spacer layer and top layer may each compose of a graphitic layer, thus forming a first (bottom) graphitic layer, a second (spacer) graphitic layer, and a third (top) graphitic layer respectively. The first (bottom) graphitic layer may be supported on one or more layers of substrate. The substrates used for the first (bottom) graphitic layer may preferably be a layer of silicon nitride (SiN_{X}) substrate and a layer of silicon (Si) substrate. The layer of silicon substrate may be beneath the layer of silicon nitride substrate.

When the bottom layer comprises a substrate and the substrate is silicon nitride (SiN_{X}), the area of the bottom graphitic layer may be in the range of about 1 μm² to about 10 mm², about 10 μm² to about 10 mm², about 100 μm² to about 10 mm², about 1000 μm² to about 10 mm², about 0.01 mm² to about 10 mm², about 0.1 mm² to about 10 mm², about 1 mm² to about 10 mm², about 1 μm² to about 10 μm², about 1 μm² to about 100 μm², about 1 μm² to about 1000 μm², about 1 μm² to about 0.01 mm², about 1 μm² to about 0.1 mm², about 1 μm² to about 1 mm², about 10 μm² to about 100 μm², about 10 μm² to about 1000 μm², about 10 μm² to about 0.01 mm², about 10 μm² to about 0.1 mm², about 10 μm² to about 1 mm², about 100 μm² to about 1000 μm², about 100 μm² to about 0.01 mm², about 100 μm² to about 0.1 mm², about 100 μm² to about 1 mm², about 1000 μm² to about 0.01 mm², about 1000 μm² to about 0.1 mm², about 1000 μm² to about 1 mm², about 0.01 mm² to about 0.1 mm², about 0.01 mm² to about 1 mm², or about 0.1 mm² to about 1 mm².

When the bottom layer comprises a substrate and the substrate is silicon nitride (SiN_{X}), the width of the bottom graphitic layer may be about 100 nm to about 1 mm, about 1000 nm to about 1 mm, about 0.001 mm to about 1 mm, about 0.01 mm to about 1 mm, about 0.1 mm to about 1 mm, about 100 nm to about 1000 nm, about 100 nm to about 0.001 mm, about 100 nm to about 0.01 mm, about 100 nm to about 0.1 mm, about 1000 nm to about 0.001 mm, about 1000 nm to about 0.01 mm, about 1000 nm to about 0.1 mm, about 0.001 mm to about 0.01 mm, about 0.001 mm to about 0.1 mm, or about 0.01 mm to about 0.1 mm larger than the width of the hole in the SiNx substrate layer.

When the bottom layer comprises a substrate and the substrate is silicon nitride (SiN_{X}), the length of the bottom graphitic layer may be about 100 nm to about 1 mm, about 1000 nm to about 1 mm, about 0.001 mm to about 1 mm, about 0.01 mm to about 1 mm, about 0.1 mm to about 1 mm, about 100 nm to about 1000 nm, about 100 nm to about 0.001 mm, about 100 nm to about 0.01 mm, about 100 nm to about 0.1 mm, about 1000 nm to about 0.001 mm, about 1000 nm to about 0.01 mm, about 1000 nm to about 0.1 mm, about 0.001 mm to about 0.01 mm, about 0.001 mm to about 0.1 mm, or about 0.01 mm to about 0.1 mm larger than the length of the hole in the SiN_{X} substrate layer.

When the bottom layer comprises a substrate and the substrate is silicon nitride (SiN_{X}), the thickness of said silicon nitride substrate may be in the range of about 10 nm to about 500 nm, about 50 nm to about 500 nm, about 100 nm to about 500 nm, about 200 nm to about 500 nm, about 300 nm to about 500 nm, about 400 nm to about 500 nm, about 10 nm to about 50 nm, about 10 nm to about 100 nm, about 10 nm to about 200 nm, about 10 nm to about 300 nm, about 10 nm to about 400 nm, about 50 nm to about 100 nm, about 50 nm to about 200 nm, about 50 nm to about 300 nm, about 50 nm to about 400 nm, about 100 nm to about 200 nm, about 100 nm to about 300 nm, about 100 nm to about 400 nm, about 200 nm to about 300 nm, about 200 nm to about 400 nm, or about 300 nm to about 400 nm. The preferred thickness of the SiN_{X} substrate may be 300 nm.

The selective layer in the spacer layer may have the following dimensions:

a length in the range of about 100 nm to about 1 mm, about 1 μm to about 1 mm, about 5 μm to about 1 mm, about 10 μm to about 1 mm, about 50 μm to about 1 mm, about 100 μm to about 1 mm, about 0.5 mm to about 1 mm, about 100 nm to about 1 μm, about 100 nm to about 5 μm, about 100 nm to about 10 μm, about 100 nm to about 50 μm, about 100 nm to about 100 μm, about 100 nm to about 0.5 mm, about 1 μm to about 5 μm, about 1 μm to about 10 μm, about 1 μm to about 50 μm, about 1 μm to about 100 μm, about 1 μm to about 0.5 mm, about 5 μm to about 10 μm, about 5 μm to about 50 μm, about 5 μm to about 100 μm, about 5 μm to about 0.5 mm, about 10 μm to about 50 μm, about 10 μm to about 100 μm, about 10 μm to about 0.5 mm, about 50 μm to about 100 μm, about 50 μm to about 0.5 mm, or about 100 μm to about 0.5 mm;

a width in the range of about 0.3 nm to about 10 μm, about 1 nm to about 10 μm, about 10 nm to about 10 μm, about 100 nm to about 10 μm, about 1 μm to about 10 μm, about 0.3 nm to about 1 nm, about 0.3 nm to about 10 nm, about 0.3 nm to about 100 nm, about 0.3 nm to about 1 μm, about 1 nm to about 10 nm, about 1 nm to about 100 nm, about 1 nm to about 1 μm, about 10 nm to about 100 nm, about 10 nm to about 1 μm, or about 100 nm to about 1 μm; and a height in the range of about 0.3 nm to about 250 nm, about 1 nm to about 250 nm, about 10 nm to about 250 nm, about 50 nm to about 250 nm, about 100 nm to about 250 nm, about 180 nm to about 250 nm, about 0.3 nm to about 1 nm, about 0.3 nm to about 10 nm, about 0.3 nm to about 50 nm, about 0.3 nm to about 100 nm, about 0.3 nm to about 180 nm, about 1 nm to about 10 nm, about 1 nm to about 50 nm, about 1 nm to about 100 nm, about 1 nm to about 180 nm, about 10 nm to about 50 nm, about 10 nm to about 100 nm, about 10 nm to about 180 nm, about 50 nm to about 100 nm, about 50 nm to about 180 nm, or about 100 nm to about 180 nm.

When the spacer layer is composed of more than one selective layer to form a stack of selective layers, this stack can be divided by patterning or etching to form multiple stacks of selective layers. The multiple stacks of selective layers may be arranged in an array on the bottom layer to form the spacer layer. The distance between one stack of selective layers from another stack of selective layers in the spacer layer may form the width of a channel in the spacer layer. When the hole in the bottom layer is a rectangle, the multiple stacks of selective layers in the spacer layer may be oriented perpendicular to the longer side of the rectangle hole in the bottom layer.

The width and height of the channels may affect the structural stability of the stacks of selective layers in the spacer layer due to the degree of Van der Waals forces between the stacks of selective layers.

The height of each stack of selective layers in the spacer layer may determine the height of the channels in the multi-layered membrane.

The spacer layer may contain at least one channel of height equivalent to the height of a stack of selective layers in the spacer layer.

The spacer layer may contain at least one channel of height in the range of about 0.3 nm to about 300 nm, about 1 nm to about 300 nm, about 10 nm to about 300 nm, about 50 nm to about 300 nm, about 100 nm to about 300 nm, about 200 nm to about 300 nm, about 0.3 nm to about 1 nm, about 0.3 nm to 10 nm, about 0.3 nm to 50 nm, about 0.3 nm to about 100 nm, about 0.3 nm to about 200 nm, about 1 nm to about 10 nm, about 1 nm to about 50 nm, about 1 nm to about 100 nm, about 1 nm to about 200 nm, about 10 nm to about 50 nm, about 10 nm to about 100 nm, about 10 nm to about 200 nm, about 50 nm to about 100 nm, about 50 nm to about 200 nm, or about 100 nm to about 200 nm from each other.

The height of the at least one channel in the spacer layer may be adjusted such that it is comparable, bigger or smaller than the hydrated ionic diameter of ions so that the multi-layered membrane may be selective towards these ions. The height of the at least one channel may be about 0.5 to about 1.3 times, such as 0.5 times, 0.6 times, 0.7 times, 0.8 times, 0.9 times, 1.0 times, 1.1 times, 1.2 times or 1.3 times the hydrated ion diameter.

The top layer may comprise a masked graphitic layer comprising a metal layer or metal oxide layer. The metal of the metal layer or the metal oxide layer may be selected from the group consisting of gold, platinum, copper, aluminium, silver, titanium, hafnium and silicon dioxide.

Exemplary, non-limiting embodiments of a method to synthesize the multi-layered membrane as disclosed herein will now be disclosed.

In an exemplary process for a multi-layered membrane comprising three graphitic layers, to form the bottom layer, the first (bottom) graphite crystal may be transferred onto the surface of the SiN_{X} substrate of a SiN_{X} substrate-Si substrate assembly, and the resulting bottom layer may be etched via dry etching such as reactive ion etching using the hole in SiN_{X} substrate as an etch mask. The second (spacer) graphitic layer may be formed via exfoliation and may be patterned thereafter by electron beam lithography and/or wet etching or dry etching, wherein the preferred process may be electron beam lithography and dry etching. Prior to assembling the bottom layer and the second graphitic layer to form the spacer layer/bottom layer assembly, the layers may be annealed at a suitable temperature ranging from 200° C. to 500° C., such as about 200° C., about 250° C., about 300° C., about 350° C., about 400° C., about 450° C., or about 500° C., or values in between. Processing contaminants such as hydrocarbons and polymer residues may be removed at this annealing step. The preferred temperature for annealing may be 400° C.

The stacks of selective layers may be released from the substrate of the spacer layer by a wet etching process, and may be transferred with a polymeric film on top of the bottom layer by a custom-made micromanipulator. The polymeric film may be removed from the stacks of selective layers by dipping the sample in solvent such as acetone and isopropyl alcohol, followed by another step of annealing at about 400° C.

When the spacer layer comprises a substrate, which is prior to assembly of the spacer layer with the bottom layer, and wherein when the substrate is silicon oxide (SiO₂), the thickness of the substrate may be in the range of about 80 nm to about 500 nm, about 100 nm to about 500 nm, about 200 nm to about 500 nm, about 300 nm to about 500 nm, about 400 nm to about 500 nm, about 80 nm to about 100 nm, about 80 nm to about 200 nm, about 80 nm to about 300 nm, about 80 nm to about 400 nm, about 100 nm to about 200 nm, about 100 nm to about 300 nm, about 100 nm to about 400 nm, about 200 nm to about 300 nm, about 200 nm to about 400 nm, or about 300 nm to about 400 nm. The preferred thickness of the SiO₂ substrate may be 300 nm.

The method to synthesize a top layer of the multi-layered membrane as disclosed herein, comprises the steps of: (a) providing a spacer layer/bottom layer assembly; (b) dry transferring a selective layer comprising a 2D material on top of the spacer layer of the spacer layer/bottom layer assembly; (c) depositing a metal layer or metal oxide layer on top of said selective layer of step (b) to form a mask; and (d) subjecting the metal layer or metal oxide layer to an etching process.

The metal of the metal layer or the metal oxide layer may be selected from the group consisting of gold, platinum, copper, aluminium, silver, titanium, hafnium and silicon dioxide.

The metal layer or the metal oxide layer may enhance the mechanical stability of the entire multi-layered membrane by holding the spacer layer/bottom layer assembly securely on the one or more layers of substrate of the bottom.

The metal layer or the metal oxide layer may also be an etch mask that protects the multi-layered membrane from the final etching process.

The process of etching using the metal layer or metal oxide layer as the etching mask may define the final length of the channels in the multi-layered membrane. The channels in the multi-layered membrane may be formed by dry etching. The part of the spacer layer in the spacer layer/bottom layer assembly covered by the etching mask may be protected from etching, while the remaining part of the spacer layer in the spacer layer/bottom layer assembly not covered by the etching mask may be attacked by the etching gas and may be removed at the end of the etching process to form spacer layer that may be trimmed at the ends.

The process of etching using the metal layer or metal oxide layer as the etching mask may result in the ends of the spacer layer being trimmed to be flushed with the top layer, which may result in a better fit of the multi-layer membrane to a device. This means that at least the length of the spacer layer (which is the side of the spacer layer that does not expose the channels) is the same as that of the top layer. Additionally or alternatively, both the length and width of the spacer layer (with the width defined as the side of the spacer layer that allows for the movement of the fluid through the channels) are the same as those of the top layer. The bottom layer (containing the 2D material) can also be etched so as to also be flushed with both the top layer and spacer layer, with the width of the bottom layer (containing the 2D material) being the same as that of the spacer layer and top layer. The length of the bottom layer (containing the 2D material) is then regarded as that of the entire bottom layer (containing the 2D material) including the hole portion.

Exemplary, non-limiting embodiments of methods for separating a plurality of ions or molecules in a fluid stream will now be disclosed.

The method for separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein the bottom layer comprises a hole that is capable of being in fluid communication with the at least one channel of the spacer layer.

The method for separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of 1 μm² to 1 mm²; and wherein the hole is capable of being in fluid communication with the at least one channel of the spacer layer

The area of the hole may alternatively be in the range of about 10 μm² to about 1 mm², about 100 μm² to about 1 mm², about 1000 μm² to about 1 mm², about 0.01 mm² to about 1 mm², about 0.1 mm² to about 1 mm², about 1 μm² to about 10 μm², about 1 μm² to about 100 μm², about 1 μm² to about 1000 μm², about 1 μm² to about 0.01 mm², about 1 μm² to about 0.1 mm², about 10 μm² to about 100 μm², about 10 μm² to about 1000 μm², about 10 μm² to about 0.01 mm², about 10 μm² to about 0.1 mm², about 100 μm² to about 1000 μm², about 100 μm² to about 0.01 mm², about 100 μm² to about 0.1 mm², about 1000 μm² to about 0.01 mm², about 1000 μm² to about 0.1 mm², or about 0.01 mm² to about 0.1 mm².

The width of the hole may be in the range of about 20 nm to about 2 μm, about 100 nm to about 2 μm, about 500 nm to about 2 μm, about 1 μm to about 2 μm, about 1.5 μm to about 2 μm, about 20 nm to about 100 nm, about 20 nm to about 500 nm, about 20 nm to about 1 μm, about 20 nm to about 1.5 μm, about 100 nm to about 500 nm, about 100 nm to about 1 μm, about 100 nm to about 1.5 μm, about 500 nm to about 1 μm, about 500 nm to about 1.5 μm, or about 500 nm to about 1.5 μm; and

the length of the hole may be in the range of about 20 nm to about 1 mm, about 100 nm to about 1 mm, about 1000 nm to about 1 mm, about 0.001 mm to about 1 mm, about 0.01 mm to about 1 mm, about 0.1 mm to about 1 mm, about 20 nm to about 100 nm, about 20 nm to about 1000 nm, about 20 nm to about 0.001 mm, about 20 nm to about 0.01 nm, about 20 nm to about 0.1 mm, about 100 nm to about 1000 nm, about 100 nm to about 0.001 mm, about 100 nm to about 0.01 mm, about 100 nm to about 0.1 mm, about 1000 nm to about 0.001 mm, about 1000 nm to about 0.01 mm, about 1000 nm to about 0.1 mm, about 0.001 mm to about 0.01 mm, about 0.001 mm to about 0.1 mm, or about 0.01 mm to about 0.1 mm.

The selective layer in the spacer layer may have the following dimensions:

a length in the range of about 100 nm to about 1 mm, about 1 μm to about 1 mm, about 5 μm to about 1 mm, about 10 μm to about 1 mm, about 50 μm to about 1 mm, about 100 μm to about 1 mm, about 0.5 mm to about 1 mm, about 100 nm to about 1 μm, about 100 nm to about 5 μm, about 100 nm to about 10 μm, about 100 nm to about 50 μm, about 100 nm to about 100 μm, about 100 nm to about 0.5 mm, about 1 μm to about 5 μm, about 1 μm to about 10 μm, about 1 μm to about 50 μm, about 1 μm to about 100 μm, about 1 μm to about 0.5 mm, about 5 μm to about 10 μm, about 5 μm to about 50 μm, about 5 μm to about 100 μm, about 5 μm to about 0.5 mm, about 10 μm to about 50 μm, about 10 μm to about 100 μm, about 10 μm to about 0.5 mm, about 50 μm to about 100 μm, about 50 μm to about 0.5 mm, or about 100 μm to about 0.5 mm;

a width in the range of about 0.3 nm to about 10 μm, about 1 nm to about 10 μm, about 10 nm to about 10 μm, about 100 nm to about 10 μm, about 1 μm to about 10 μm, about 0.3 nm to about 1 nm, about 0.3 nm to about 10 nm, about 0.3 nm to about 100 nm, about 0.3 nm to about 1 μm, about 1 nm to about 10 nm, about 1 nm to about 100 nm, about 1 nm to about 1 μm, about 10 nm to about 100 nm, about 10 nm to about 1 μm, or about 100 nm to about 1 μm; and a height in the range of about 0.3 nm to about 250 nm, about 1 nm to about 250 nm, about 10 nm to about 250 nm, about 50 nm to about 250 nm, about 100 nm to about 250 nm, about 180 nm to about 250 nm, about 0.3 nm to about 1 nm, about 0.3 nm to about 10 nm, about 0.3 nm to about 50 nm, about 0.3 nm to about 100 nm, about 0.3 nm to about 180 nm, about 1 nm to about 10 nm, about 1 nm to about 50 nm, about 1 nm to about 100 nm, about 1 nm to about 180 nm, about 10 nm to about 50 nm, about 10 nm to about 100 nm, about 10 nm to about 180 nm, about 50 nm to about 100 nm, about 50 nm to about 180 nm, or about 100 nm to about 180 nm.

The spacer layer may contain at least one channel of height in the range of about 0.3 nm to about 300 nm, about 1 nm to about 300 nm, about 10 nm to about 300 nm, about 50 nm to about 300 nm, about 100 nm to about 300 nm, about 200 nm to about 300 nm, about 0.3 nm to about 1 nm, about 0.3 nm to 10 nm, about 0.3 nm to 50 nm, about 0.3 nm to about 100 nm, about 0.3 nm to about 200 nm, about 1 nm to about 10 nm, about 1 nm to about 50 nm, about 1 nm to about 100 nm, about 1 nm to about 200 nm, about 10 nm to about 50 nm, about 10 nm to about 100 nm, about 10 nm to about 200 nm, about 50 nm to about 100 nm, about 50 nm to about 200 nm, or about 100 nm to about 200 nm from each other.

The height of the at least one channel in the spacer layer may be adjusted such that it is comparable, bigger or smaller than the hydrated ionic diameter of ions so that the multi-layered membrane may be selective towards these ions. The height of the at least one channel may be about 0.5 to about 1.3 times, such as 0.5 times, 0.6 times, 0.7 times, 0.8 times, 0.9 times, 1.0 times, 1.1 times, 1.2 times or 1.3 times the hydrated ion diameter.

The method may be altered such that step (a) provides a plurality of multi-layered membranes for separating a plurality of ions or molecules in a fluid stream.

The method may generate osmotic voltage and/or osmotic current due to the differential ionic mobilities induced between the cations and anions as compared to their bulk values.

The driving force may be saline concentration gradient of the fluid stream. The saline concentration gradient of the fluid stream may be about 3 to about 1000, about 10 to about 1000, about 100 to about 1000, about 200 to about 1000, about 500 to about 1000, about 3 to about 10, about 3 to about 100, about 3 to about 200, about 3 to about 500, about 10 to about 100, about 10 to about 200, about 10 to about 500, about 100 to about 200, about 100 to about 500, or about 200 to about 500.

The fluid stream may have an average saline concentration of about 2 mM to about 1.5 M, about 10 mM to about 1.5 M, about 100 mM to about 1.5 M, about 500 mM to about 1.5 M, about 1 M to about 1.5 M, about 2 mM to about 10 mM, about 2 mM to about 100 mM, about 2 mM to about 500 mM, about 2 mM to about 1 M, about 10 mM to about 100 mM, about 10 mM to about 500 mM, about 10 mM to about 1 M, about 100 mM to about 500 mM, about 100 mM to about 1 M, or about 500 mM to about 1 M, where the average concentration is the average value of the saline concentrations across both surfaces of the membrane.

Exemplary, non-limiting embodiments of a device and use of method or device as disclosed herein will now be disclosed.

The device comprises a multi-layered membrane comprising a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of about 1 μm² to 1 mm²; and wherein the hole is capable of being in fluid communication with the at least one channel of the spacer layer.

The size of the hole may alternatively be in the range of about 10 μm² to about 1 mm², about 100 μm² to about 1 mm², about 1000 μm² to about 1 mm², about 0.01 mm² to about 1 mm², about 0.1 mm² to about 1 mm², about 1 μm² to about 10 μm², about 1 μm² to about 100 μm², about 1 μm² to about 1000 μm², about 1 μm² to about 0.01 mm², about 1 μm² to about 0.1 mm², about 10 μm² to about 100 μm², about 10 μm² to about 1000 μm², about 10 μm² to about 0.01 mm², about 10 μm² to about 0.1 mm², about 100 μm² to about 1000 μm², about 100 μm² to about 0.01 mm², about 100 μm² to about 0.1 mm², about 1000 μm² to about 0.01 mm², about 1000 μm² to about 0.1 mm², or about 0.01 mm² to about 0.1 mm².

The multi-layered membrane may be oriented parallel to the liquid interface between two liquids.

The device may be altered such the device comprises a plurality of multi-layered membranes.

The device may further comprise two or more chambers, wherein the multi-layered membrane may be placed between two chambers. Each of the chambers may be intended for receiving an electrolyte solution having a chemical potential. The device may further comprise electrodes partially or fully submerged in the electrolytic solution. In an example, each chamber containing the electrolyte solution is in direct contact with one electrode. A pair of electrodes may be configured such that the electrodes are connected via a generator load or electric load.

Within the device, the top layer of the multi-layered membrane may be in contact with only one chamber, while the bottom layer may be mostly in contact with another chamber.

Due to the difference in the electrochemical potential between the various electrolyte solutions in two or more chambers, ions or molecules in the electrolytic solution may pass through the multi-layered membrane. Ionic species having different charge or valence may pass through the multi-layered membrane. The ionic species having different charge or valence may have enhanced mobility within the at least one channel of the multi-layered membrane and may diffuse through the at least one channel at different speed, resulting in the imbalance of the charge neutrality of the system, thus generating an osmotic voltage and/or osmotic current. The osmotic voltage and/or osmotic current may generate electrical energy, which may be collected by a generator load.

The electrochemical potential may arise due to a saline concentration gradient between the various electrolyte solutions in the two or more chambers. The saline concentration gradient of about 3 to about 1000, about 10 to about 1000, about 100 to about 1000, about 200 to about 1000, about 500 to about 1000, about 3 to about 10, about 3 to about 100, about 3 to about 200, about 3 to about 500, about 10 to about 100, about 10 to about 200, about 10 to about 500, about 100 to about 200, about 100 to about 500, or about 200 to about 500, may generate an osmotic voltage and/or osmotic current in the device.

The fluid within the two or more chambers may have an average saline concentration of about 2 mM to about 1.5 M, about 10 mM to about 1.5 M, about 100 mM to about 1.5 M, about 500 mM to about 1.5 M, about 1 M to about 1.5 M, about 2 mM to about 10 mM, about 2 mM to about 100 mM, about 2 mM to about 500 mM, about 2 mM to about 1 M, about 10 mM to about 100 mM, about 10 mM to about 500 mM, about 10 mM to about 1 M, about 100 mM to about 500 mM, about 100 mM to about 1 M, or about 500 mM to about 1 M, to generate an osmotic voltage and/or osmotic current in the device, where the average concentration is the average value of the saline concentrations in the two or more chambers of the device.

The method or the device as disclosed herein, can be used in osmotic power generation. There is thus provided use of the method as disclosed herein or the device as disclosed herein for osmotic power generation.

With reference to use of the device, there is provided use of a device comprising a multi-layered membrane for osmotic power generation wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein the bottom layer comprises a hole that is capable of being in fluid communication with the at least one channel of the spacer layer.

In the multi-layered membrane, the hole in the bottom layer may have an area in the range of about 1 μm² to 1 mm². Therefore, there is also provided use of a device comprising a multi-layered membrane for osmotic power generation wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein the bottom layer comprises a hole with an area in the range of 1 μm² to 1 mm²; and wherein the hole is capable of being in fluid communication with the at least one channel of the spacer layer.

With reference to use of the method or method used in osmotic power generation, there is provided a method for generating osmotic power by separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; and wherein the bottom layer comprises a hole that is capable of being in fluid communication with the at least one channel of the spacer layer.

In the multi-layered membrane, the hole in the bottom layer may have an area in the range of about 1 μm² to 1 mm². Therefore, there is also provided a method for generating osmotic power by separating a plurality of ions or molecules in a fluid stream comprising the steps of: a) providing a multi-layered membrane; b) contacting a first surface of the multi-layered membrane with the fluid stream under a driving force to selectively allow desired ions or molecules to pass through to a second surface; wherein first surface of the multi-layered membrane is optionally charged; and wherein the multi-layered membrane comprises a top layer, a bottom layer, and a spacer layer; wherein the spacer layer is interposed between the top layer and the bottom layer; wherein the top layer, the bottom layer and the spacer layer are each independently composed of one or more selective layers, each selective layer comprising a 2D material; wherein the spacer layer comprises at least one channel for receiving a fluid; wherein the bottom layer comprises a hole with an area in the range of 1 μm² to 1 mm²; and wherein the hole is capable of being in fluid communication with the at least one channel of the spacer layer.

By separating the plurality of ions or molecules in the fluid stream, each ion species or molecule may move at different mobilities as compared to each other, or when compared to the typical mobility when in a bulk phase. Due to the different mobilities between cations and anions, an osmotic voltage and osmotic current is generated, leading to a generation of osmotic power.

The osmotic power generated (P) may be in the range of about 3 W/m² to about 10 kW/m², of about 10 W/m² to about 10 kW/m², about 100 W/m² to about 10 kW/m², about 1 kW/m² to about 10 kW/m², about 5 kW/m² to about 10 kW/m², of about 3 W/m² to about 10 W/m², about 3 W/m² to about 100 W/m², about 3 W/m² to about 1 kW/m², about 3 W/m² to about 5 kW/m², about 10 W/m² to about 100 W/m², about 10 W/m² to about 1 kW/m², about 10 W/m² to about 5 kW/m², about 100 W/m² to about 1 kW/m², about 100 W/m² to about 5 kW/m², or about 1 kW/m² to about 5 kW/m², where osmotic power (P) may be calculated based on 25% of the product of the osmotic voltage (Vₒₛₘ) and osmotic current (Iₒₛₘ).

The energy efficiency of osmotic power generation may be in the range of about 5% to about 25%, about 10% to about 25%, about 15% to about 25%, about 20% to about 25%, about 5% to about 10%, about 5% to about 15%, about 5% to about 20%, about 10% to about 15%, about 10% to about 20%, or about 15% to about 20%.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic illustration of the structure of a device comprising a multi-layered membrane (600) comprising a top layer, a bottom layer, and a spacer layer, wherein each chamber (400, 500) is intended for receiving an electrolyte solution with a given chemical potential, wherein each electrolyte solution is in direct contact with one electrode (200, 300), and the electrodes are configured to be connected to a generator load (100). In this case, the arrows show the movement of the ions due to diffusion from the higher saline concentration chamber (400) to the lower saline concentration chamber (500).

FIG. 2A is an illustration of the structure of a multi-layered membrane (600) used in the device of FIG. 1. The multi-layered membrane (600) comprises of a bottom layer (700), a spacer layer (800) and a top layer (900), where the spacer layer (800) comprises an array of stacks of selective layers, such that each stack of selective layers (1000) is separated from the next by a channel (1100). The top layer (900) comprises of a top graphitic layer (2000) and a metal or metal oxide layer (2100). The directions of the arrows show the movement of the ions in the solution through the hole in the bottom layer and passing out from the channels (1100) of the spacer layer (800).

FIG. 2B is an illustration of the cross sectional view of the bottom layer (700) of the multi-layered membrane (600) used in the device of FIG. 1, which comprises of a bottom graphitic layer (1600) supported by a silicon nitride substrate layer (1200) and a silicon layer (1900).

FIG. 2C is an illustration of the SiNx substrate layer (1200) used as the support for the bottom layer (700), where the 300 nm thick SiNx substrate (1200) has a rectangular hole (1300) of about 10 μm² in size, where length (1400) is about 10 μm and width (1500) is about 1 μm.

FIG. 2D is an illustration of the cross-sectional view of the spacer layer (800) of the multi-layered membrane (600) used in the device of FIG. 1, comprising of stacks of selective layers, where each stack of selective layers (1000) has a height (1700) and is separated from the next stack of selective layers by a channel (1100) of a distance (1800). The distance (1800) is referred to as the width of the channel. The height of a channel is also represented by 1700, similar to the height of a stack of selective layers (1000).

FIG. 3A is a plot showing the relationship between the ionic conductance of the device normalized to the ionic conductivity of the solution (G/G_{Bulk}), in the absence of concentration gradient where Cᵢ=C₀=1 M, and the height (1700, in angstrom, Å) of a channel (1100) of FIG. 2D. Cᵢ and C₀ being the saline concentration in each of the chambers (500 and 400) of FIG. 1.

FIG. 3B is a plot showing the relationship between the ionic mobility of the device for the cations (K⁺) and anions (Cl⁻) normalized to the ionic mobility of the solution (μ/μ_{Bulk}), in the presence of a concentration gradient of 3:1 where Cᵢ=0.3 M and C₀=0.1 M, and the height (1700, in angstrom, Å) of a channel (1100) of FIG. 2D. Cᵢ and C₀ being the saline concentration in each of the chambers (500 and 400) of FIG. 1.

FIG. 3C is a plot showing the relationship between the transference number of the cation (IC) of the device at different electrolyte concentrations but fixed diffusion potential (i.e. fixed concentration gradient of 3:1), at heights of 7 Å and 30 Å of a channel (1100) of FIG. 2D. C_{avg} being the average value of the saline concentration in each of the chambers (400 and 500) of FIG. 1 (i.e. (Cₒ+Cᵢ)/2).

FIG. 4A is a plot showing the ionic mobility of the device for the cations (K⁺) and anions (Cl⁻) normalized to the ionic mobility of the solution (μ/μ_{Bulk}) as a function of concentration gradient, while the inset plot show the ratio of the ionic mobility of the cations ((K⁺) to anions (Cl⁻) as a function of concentration gradient. Cᵢ and Cₒ represents the saline concentration in each of the chambers (500 and 400) of FIG. 1.

FIG. 4B is a plot showing the ionic mobility of the device for the cations (K⁺ or Na⁺) and anions (Cl⁻) normalized to the ionic mobility of the solution (μ/μ_{Bulk}) as a function of different electrolyte concentrations and different concentration gradient. Cᵢ and C₀ represents the saline concentration in each of the chambers (400 and 500) of FIG. 1, and C_{avg} represents the average value of the saline concentration in each of the chambers (400 and 500) of FIG. 1 (i.e. (Cₒ+Cᵢ)/2).

FIG. 5A is a plot showing the maximum osmotic power generated (kW/m²) in the device as a function of different salinity gradient and concentration when the height (1700, in angstrom, Å) of a channel (1100) of FIG. 2D), is 7 Å.

FIG. 5B is a plot showing the maximum energy efficiency (%) in the device as a function of different salinity gradient and concentration when the height (1700, in angstrom, Å) of a channel (1100) of FIG. 2D, is 7 Å.

FIG. 5C is a plot showing the relationship between the transference number of the cation (K⁺) of the device at different electrolyte concentrations where the height (1700, in angstrom, Å) of a channel (1100) of FIG. 2D, is at 7 Å and 30 Å, and the concentration gradient of varies from 3:1 to 1000:1.

FIG. 5D is a plot showing the maximum osmotic power generated (kW/m²) in the device as a function of the height (1700, in angstrom, Å) of a channel (1100) of FIG. 2D, at a fixed concentration gradient of 100.

### EXAMPLES

Non-limiting examples of the invention will be further described in greater detail by reference to specific Examples, which should not be construed as in any way limiting the scope of the invention.

Materials

All the reagents were obtained from commercial suppliers and used without further purification. Commercially available solvents like acetone and isopropyl alcohol were purchased from Sigma-Aldrich (USA). Graphite and other 2D materials were purchased from HQ Graphene (Netherlands). The purchased silicon nitride (SiN_{X}) substrate was grown on top of a 400 μm thick silicon (Si) layer. Both the SiN_{X} and Si are in the shape of a circle with a 10.16 cm (4 inches) diameter wafer and are double-side polished.

### Example 1: Synthesis of a Multi-Layered Membrane

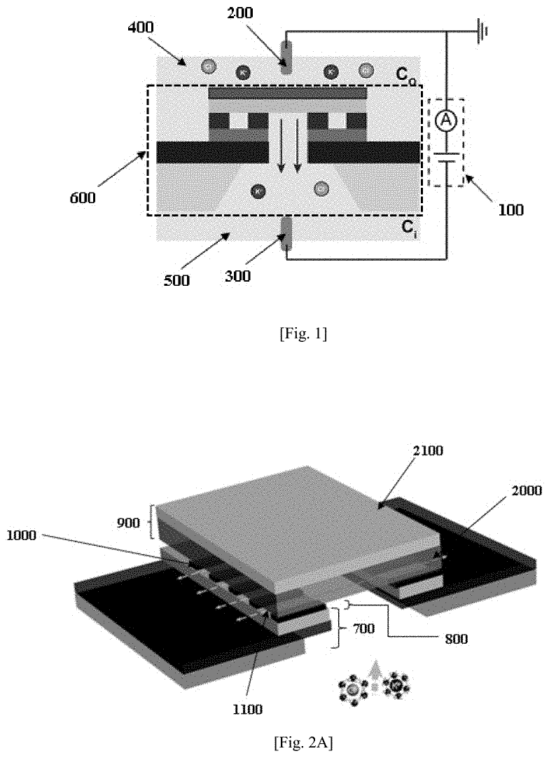

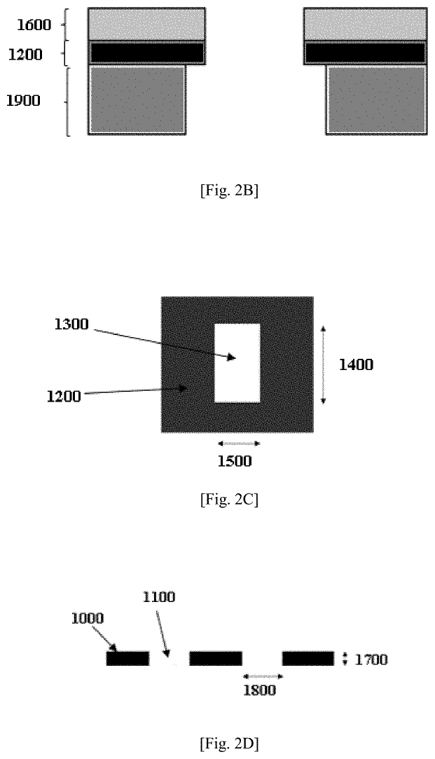

To demonstrate the concept of blue energy generation, a device as shown in FIG. 1 will be used and it requires a suitable active multi-layered membrane (600) to be placed in between the two chambers (400, 500), each chamber containing its own electrolyte solution of concentration Cₒ and Cᵢ respectively. As shown in FIG. 2A, the multi-layered membrane comprises a plurality of multi-layered structures stacked upon one another, wherein the spacer layer comprises an array of stacks of selective layers such that each stack of selective layer (1000) is separated from the next by a channel (1100). The multi-layered membrane has channels for passing the ions and molecules through the multi-layered membrane. Because of the difference in chemical potential of the electrolyte solutions between the two chambers (400, 500) of the device in FIG. 1, ions or molecules will pass through the active multi-layered membrane (600). Ionic species with different charge or valence will have an enhanced mobility within the channels of the active multi-layered membrane and will diffuse through the channels at different speeds. This will cause an imbalance in the charge neutrality of the system, resulting in an osmotic current and osmotic potential. These osmotic potential and current generate an electrical power that is collected by the generator load (100) through the electrodes (200, 300).

To prepare a prototype multi-layered membrane of trilayer structure as shown in FIG. 2A, three graphitic crystal layers were isolated by mechanical exfoliation. To obtain the graphitic crystal layers, a thick graphite crystal is laid on a low-residue tape. The thick graphite crystal is then pressed between another piece of the same tape to cleave the graphite crystal into two pieces. The process is repeated for several times till the piece of tape is fully covered with such crystals. The final thickness of those flakes is between 0.3 nm to 500 μm, with an area size of few microns square to millimetre square.

Firstly, to prepare the bottom layer (700), a graphitic crystal layer (1600) prepared by mechanical exfoliation as described above was transferred onto a substrate (1200) as shown in FIG. 2B, where the substrate (1200) is a 300 nm thick silicon nitride (SiN_{X}) substrate (1200) with a rectangular hole (1300) of about 1×10 μm² as shown in FIG. 2C. This layer of SiN_{X} substrate is supported by a layer of silicon (Si) substrate (1900). This graphitic layer (1600) is then etched by reactive ion etching using the rectangular hole (1300) in the SiN_{X} substrate (1200) as an etch mask. Therefore, the dimension of the hole in the graphitic layer (1600) is identical to that in the substrate (1200). Reference to the “hole” in the context of this disclosure is thus the hole that is present in the graphitic layer (1600).

Next, graphitic layers as selective layers, each with a height ranging from 0.7 nm to 35 nm were exfoliated onto a 300 nm thick SiO₂ substrate to form a stack of selective layers. Approximately 2 to 117 graphene layers as selective layers was used. The height (1700) of each stack of selective layers was confirmed by measuring using atomic force microscopy (Dimension FastScan, Bruker, USA) in tapping mode. This stack of selective layers is then patterned by electron beam lithography and dry etching onto the bottom graphitic layer, in an array of ribbons which are now stacks of selective layers, where each stack of selective layers (1000) is of several microns in width, 150 nm in length and spaced at a distance (1800) of 100 nm from each other, to form the second (spacer) graphitic layer as shown in FIG. 2D prior to stacking on top of the bottom layer. This spacer graphitic layer contains nanometer-sized channels (1100) wherein the height (1700) of each channel (1100) is equivalent to the height of a stack of selective layers (1000) in the spacer layer.

The selective layers in the spacer graphitic layer were annealed at 400° C. prior to assembling with the bottom layer. At this annealing temperature, contaminants such as hydrocarbons and polymer residues are removed. The stacks of selective layers are then released from the SiO₂ substrate by a wet etching process and transferred with a polymeric film on top of the bottom layer (700) by a custom-made micromanipulator. The polymeric film was then removed from the stacks of selective layers by dipping the sample in acetone and isopropyl alcohol, followed by another step of annealing at 400° C.

After assembling the bottom and spacer graphitic layers, a thick graphitic layer (2000) of about 50 to 120 nm was exfoliated on SiO₂ and transferred in a manner like previously done for the spacer layer, on top of the spacer layer of the bottom layer/spacer layer assembly as a top graphitic layer, and a gold mask (2100) was deposited on top of the top graphitic layer (2000). Thereafter, a final dry etching step removes the part of the channels that is not protected by the gold layer (2100), hence defining the final length of the channels. The final dry etching step results in the extremes of the spacer layer (800) being flushed with the top layer (900), which may result in a better fit of the multi-layer membrane (600) to a device.

### Example 2: Characterization of Multi-Layered Membrane Performance in a Device

The multi-layered membrane as synthesized in Example 1 was incorporated into a device as shown in FIG. 1 and subjected to testing to characterize the multi-layered membrane's performance. The multi-layered membrane (600) was integrated perpendicular to the ionic solutions in the two chambers (400 and 500).

Characterization of the ionic conductance of the multi-layered membrane was done using the Axopatch 200B Patch-Clamp Amplifier (Molecular Devices, USA). A voltage, sweeping at 200 mV to 200 mV, was applied between the two Ag/AgCl electrodes. The resulting current was measured by the Axonpatch 200B Patch-Clamp Amplifier. The multi-layered membrane conductance at each ionic concentration was then extracted from the slope of the measured current vs voltage curve. By using the Henderson and GHK formalism, the individual ionic mobilities were extracted.

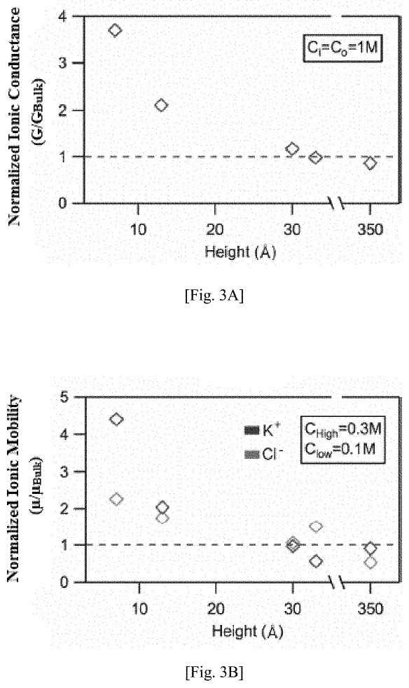

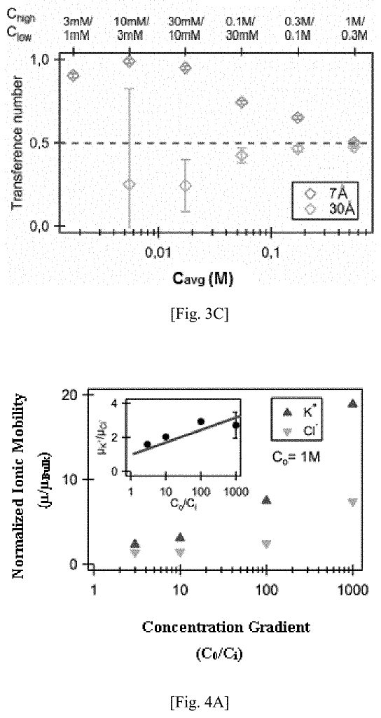

Based on the results of FIG. 3A, an enhanced ionic conductance (i.e. G/G_{Bulk}>1) was observed in the device when the height of each channel in the spacer layer is at 3 nm or less, and this phenomenon was observed in the absence of a concentration gradient. The smaller the height of each channel in the spacer layer, the greater the ionic conductance achieved, with the highest ionic conductance observed for 7 Å high channels. This enhancement of ionic conductance may be due to different ionic mobilities of ions and molecules inside the channels as shown in FIG. 3B as compared to their bulk values, and their 2D physical confinement with these channels.

It is well known that water through graphene nanocapillaries shows an increased structural order that leads to fast water flow and slip lengths that can go up to several hundreds of nanometers. For the smallest channels of the membrane in the present disclosure, the height of each channel at 7 Å is comparable to the hydrated ion diameter and the total ionic conductivity is significantly related to the ionic diffusivity at the surface. It has been proven experimentally and by Density Functional Theory (DFT) calculations that graphene interacts with ions in its close vicinity via the delocalized it-electrons, leading to preferential absorption of cations. This phenomenon combined with the preferred alignment of dipolar water molecules in the near-surface region corresponds to an enhanced diffusivity of cations and reduced flow of anions. At high saline concentrations of more than 0.1 M, ion-ion correlations become significant and the enhanced selectivity is disrupted. For the device with height of channels greater than 30 Å, the ionic conductance is comparable to the bulk solution, indicating a complete disruption of the physical confinement effect and a smaller contribution of the surface conductivity to the total ionic conductance.

Based on the results of FIG. 3B, it was found that the ionic mobility of the ions inside the channels are higher than in a bulk solution, although it was expected that the ions inside a confined and restricted space would move equally or slower than in a bulk solution where they are free to move in any direction. Further, the results of FIG. 3B showed that the cations can move faster than the anions when the height of the channel is below 30 Å, and hence the membrane is exhibiting cation selectivity. This is surprising because the cations K⁺ have a similar size to the anions Cl— and it would be expected for the ionic mobilities of the two types of ions to be similar, however the results showed ionic selectivity, which in this case is for the cations K⁺.

To obtain more insights on the different ionic diffusivity under physical confinement, cationic transference number was extrapolated from the osmotic potential at different electrolyte concentrations with fixed diffusion potential (where concentration gradient was fixed at 3:1) as depicted in FIG. 3C. Based on the results of FIG. 3C, in the case of highly confined channels of height 7 Å, the enhanced mobility of cations corresponds to a high anionic rejection. This surface-related effect becomes insignificant only at very high saline concentrations (for example more than 1 M) when ion-ion correlations become significant. In less confined systems as seen for channels of height 30 Å, cation selectivity was not observed. In contrary, anions Cl⁻ ions show a higher diffusivity than cations K⁺ because of the chemical interaction of K⁺ ions with the graphitic surface of the multi-layered membrane. In addition, for the less confined systems as seen for channels of height 30 Å, at high saline concentrations, the effect of higher anion diffusivity is progressively reduced until it is completely cancelled for concentrations above 0.1 M.

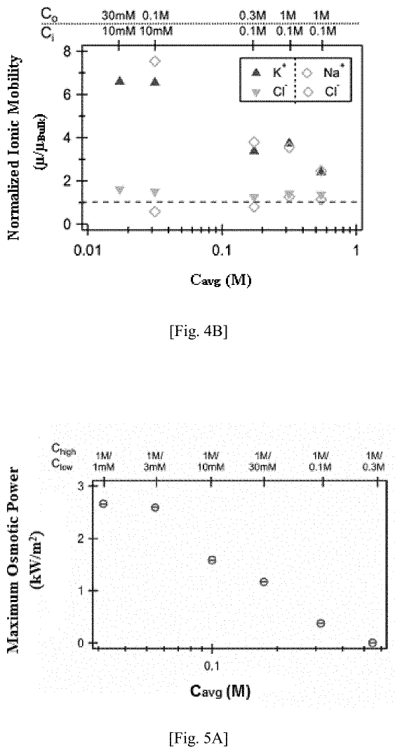

Further, based on the results of FIG. 4A, which represents the ionic mobility of K⁺ cations and Cl⁻ anions normalized with respect to their bulk values under a saline concentration gradient, by increasing the saline concentration gradient from 3 to 1000, K⁺ cations move faster with respect to the Cl⁻ anions as show in the inset diagram. In addition, FIG. 4A showed that when saline concentration gradients equal or bigger than 3 both Cl⁻ and K⁺ ions show enhanced ionic mobility with respect to the bulk solution.

Based on the results of FIG. 4B, which represents the ionic mobility of cations and anions normalized with respect to their bulk values under a saline concentration gradient of 3 or 10. For such small saline concentration gradient, regardless of the average saline concentration inside the channels of the multi-layered membrane, anions show minimal variation of ionic mobility with respect to the bulk while cations show an increased mobility for each saline concentration gradient. This cation ionic mobility enhancement (valid both for K⁺ and Na⁺) is inversely proportional to the average saline concentration inside the channels of the multi-layered membrane.

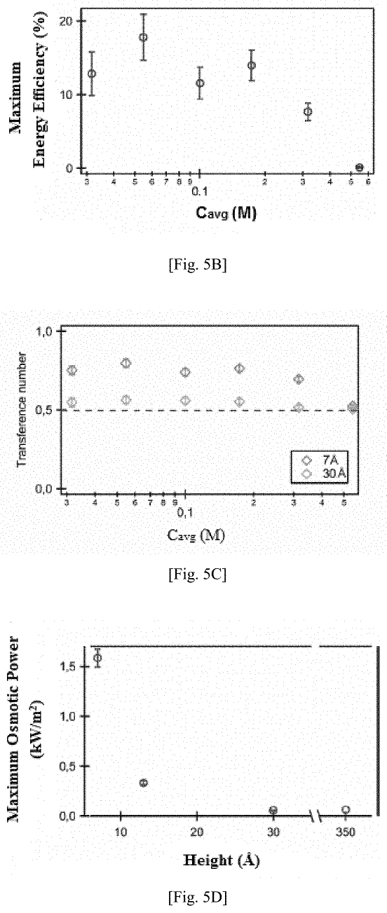

Based on the measured osmotic potential in different salinity gradient of the device, the maximum osmotic power generated (FIG. 5A), maximum energy efficiency (FIG. 5B) and cationic transference number (FIG. 5C) were obtained. The maximum osmotic power (P) was calculated based on 25% of the product of the osmotic voltage (Vₒₛₘ) and osmotic current (Iₒₛₘ) from the current-voltage curve measured under the conditions of a salinity gradient, that is P=¼×Vₒₛₘ×Iₒₛₘ. From FIG. 5A, it was observed that high power densities in the order of kW/m² were obtained for the device when the height of the channels is at 7 Å and concentration ratios are high, wherein the power densities are 3 orders of magnitudes higher than commercially available membranes. Due to the increased cationic selectivity in the highly confined channels of 7 Å height, the maximum energy efficiency can reach as high as 16% as observed in FIG. 5B. Based on results of FIG. 5C, under high confinement the cation selectivity is high and close to 75% (0.75/1) while for devices with reduced physical confinement the cation selectivity is very low, corresponding to a cation transference number close to 0.5. As a result, the power density was drastically reduced in channels with higher heights and less physical confinement as shown in FIG. 5D.

### INDUSTRIAL APPLICABILITY

The membrane and multi-layered membrane as disclosed herein may be deposited on a support or embedded in a matrix, to serve as an active membrane when it is incorporated into another membrane or system.

Since the method as disclosed herein comprises the use of a membrane or multi-layered membrane which has ionic selectivity, an osmotic voltage and/or an osmotic current may be generated and thus, the method may be suitable for blue energy generation and storage where there is salinity gradient, for example in water desalination plants, nanofiltration, ion-exchange, brine-disposal and water filtration operations, and may find many commercial applications in water purification, pharmaceutical, chemical and fuel separation industries.

The device as disclosed herein may be energy efficient and generate high power densities suitable for commercial blue energy recovery applications.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A multi-layered membrane comprising a top layer, a bottom layer, and a spacer layer;
wherein said spacer layer is interposed between said top layer and said bottom layer;
wherein said top layer, said bottom layer and said spacer layer are each independently composed of one or more selective layers, each selective layer comprising a 2D material;
wherein said spacer layer comprises at least one channel for receiving a fluid;
wherein said bottom layer comprises a hole with an area in the range of 1 μm² to 1 mm²; and
wherein said hole is capable of being in fluid communication with said at least one channel of said spacer layer.

2. The multi-layered membrane of claim 1, wherein width of said hole is in the range of 20 nm to 2 μm, and length of said hole is in the range of 300 nm to 1 mm, or
wherein said 2D material is a nanoparticle, or
wherein said 2D material is selected from the group consisting of graphene, graphite, hexagonal boron nitride, transition metal dichalcogenide, phosphorene, xene, transitional metal-xene, and combinations thereof.

3. (canceled)

4. (canceled)

5. The multi-layered membrane of claim 2, wherein said transition metal dichalcogenide has a chemical formula MX2, wherein M is a transition metal selected from the group consisting of titanium, vanadium, chromium, manganese, zirconium, niobium, molybdenum, technetium, hafnium, tantalum, tungsten and rhenium; and
wherein X is a chalcogen selected from the group consisting of sulfur, selenium and tellurium, or
wherein said xene is selected from the group consisting of borophene, silicene, germanene, stanene, phosphorene, arsenene, antimonene, bismuthene, and tellurene.

6. (canceled)

7. The multi-layered membrane of claim 1,
wherein said bottom layer comprises one or more layers of substrate;
wherein said substrate is independently selected from the group consisting of silicon, silicon nitride (SiN_{X}), silicon oxide (SiO₂), alumina (Al₂O₃), anodic aluminium oxide, aluminium oxide, titanium dioxide, hafnium dioxide, nylon, polymer, polyether sulfone, polyvinyl alcohol (PVA), polycarbonate (PC), and polyvinylidene fluoride.

8. The multi-layered membrane of claim 7, wherein said substrate is a mechanical support for said bottom layer.

9. The multi-layered membrane of claim 1, wherein said top layer, bottom layer or spacer layer is independently surface-functionalized.

10. The multi-layered membrane of claim 9, wherein said surface-functionalized top layer, surface-functionalized bottom layer or surface-functionalized spacer layer has a different hydrophilicity or hydrophobicity as compared to a non surface-functionalized top layer, bottom layer or spacer layer.

11. The multi-layered membrane of claim 7, wherein when said bottom layer comprises a layer of silicon nitride (SiN_{X}) substrate, and the area of said bottom layer is in the range of 25 μm² to 10 mm², the thickness of said silicon nitride substrate is in the range of 10 nm to 500 nm.

12. The multi-layered membrane of claim 11, wherein said bottom layer comprises a layer of silicon substrate beneath said layer of silicon nitride substrate.

13. The multi-layered membrane of claim 1 wherein the height of each selective layer in said spacer layer is in the range of 0.3 nm to 250 nm.

14. (canceled)

15. The multi-layered membrane of claim 1, wherein said top layer comprises a masked graphitic layer comprising a metal layer or metal oxide layer thereon.

16. The multi-layered membrane of claim 15, wherein the metal of said metal layer or said metal oxide layer is selected from the group consisting of gold, platinum, copper, aluminium, silver, titanium, hafnium and silicon dioxide.

17. A method to synthesize a top layer of a multi-layered membrane as defined in claim 15, comprising the steps of:
(a) providing a spacer layer/bottom layer assembly;
(b) dry transferring a selective layer comprising a 2D material on top of the spacer layer of the spacer layer/bottom layer assembly;
(c) depositing a metal layer or metal oxide layer on top of said selective layer of step (b) to form a mask; and
(d) subjecting said metal layer or metal oxide layer to an etching process.

18. A method for separating a plurality of ions or molecules in a fluid stream comprising the steps of:
a) providing a multi-layered membrane;
b) contacting a first surface of said multi-layered membrane with said fluid stream under a driving force to selectively allow desired ions or molecules to pass through to a second surface;
wherein first surface of said multi-layered membrane is optionally charged; and
wherein said multi-layered membrane comprises a top layer, a bottom layer, and a spacer layer;
wherein said spacer layer is interposed between said top layer and said bottom layer;
wherein said top layer, said bottom layer and said spacer layer are each independently composed of one or more selective layers, each selective layer comprising a 2D material;
wherein said spacer layer comprises at least one channel for receiving a fluid; and
wherein said bottom layer comprises a hole that is capable of being in fluid communication with said at least one channel of said spacer layer, said hole optionally having an area in the range of 1 μm² to 1 mm².

19. (canceled)

20. The method of claim 18, wherein when said driving force is the saline concentration gradient of said fluid stream across said multi-layered membrane, the said saline concentration gradient of said fluid stream is in the range of 3 to 1000, or
wherein the average saline concentration of said fluid stream is in the range of 2 mM to 1.5 mM.

21. (canceled)

22. A device comprising a multi-layered membrane comprising a top layer, a bottom layer, and a spacer layer;
wherein said spacer layer is interposed between said top layer and said bottom layer;
wherein said top layer, said bottom layer and said spacer layer are each independently composed of one or more selective layers, each selective layer comprising a 2D material;
wherein said spacer layer comprises at least one channel for receiving a fluid;
wherein said bottom layer comprises a hole with an area in the range of 1 μm² to 1 mm²; and
wherein said hole is capable of being in fluid communication said at least one channel of with said spacer layer.

23. The device of claim 22, further comprising two or more chambers, wherein said membrane is placed between two chambers.

24. The device of claim 22, wherein the saline concentration gradient of said fluid is in the range of 3 to 1000, or
wherein the average saline concentration of said fluid is in the range of 2 mM to 1.5 M.

25. (canceled)

26. (canceled)
